(19) United States
(12) Patent Application Publication
(10) Pub. No.: US 2015/0052706 A1
(43) Pub. Date: Feb. 26, 2015

(54) HINGE APPARATUS FOR MESSAGE CLIP BOARDS

(71) Applicant: Robert W. Kalis, Mesa, AZ (US)

(72) Inventor: Robert W. Kalis, Mesa, AZ (US)

(21) Appl. No.: 13/971,853

(22) Filed: Aug. 21, 2013

(51) Int. Cl. E05D 7/00; E05D 5/14

(52) U.S. Cl. CPC E05D 7/00; E05D 5/14
USPC 16/224

(57) ABSTRACT

A hinged apparatus for message clip boards where a message board is allowed to pivot at least 180 degrees along one vertical edge of the message board to allow a message board to be mounted to the side wall of an object, such as a refrigerator, and that would allow the message board to be position at or near zero degrees, to hide the visibility of the board to an angle greater than zero, such as 90 degrees, to position the board parallel with the front of the object (refrigerator) so as to be fully visible. The hinge apparatus featuring a thin vertical bar used to support the message board with minimum surface contact along any metallic strip in a object, wall, refrigerator etc.

### BACKGROUND

### Prior Art

Message and clip boards have many variations and means for connecting to a surface. In particular, a message center in the kitchen will often involve a refrigerator for displaying messages. A typical set up usually involve mounting the message board to the front surfaces of the doors using magnets, suction cups or tape to hold the message board to the surface. More extravagant message boards may included a white erasable pen surface used to write messages on and additional compartments for holding supplies. Side mounting to a refrigerator is possible with these same devices but the main viewing surface is typical parallel with the mounting surface. This fixed side mounting makes the visible front hard to see. All prior message board systems tend to have a main rectangular base from which to attach the many variations such as doors, containers, holders to name a few.

U.S. Pat. No. 8,047,851 to Baxter (2008) is a display center featuring many message board surfaces on a multi-hinge mechanism which also contains a compartment to hold items. Patent 2007/0290588 to Oh (2007) describes a hinged display attached to the front of a refrigerator. The invention describes an indented section formed into the refrigerator door to allow the display to lay flat when pushed into the door. This patent would involve a more permanent attachment to the wall. Patent 2006/0225331 to Evans (2006) shows a magnetic display system comprising of a primary fixed panel and secondary panels attached with hinges. The secondary panels have a 1^{st} and second surface for message displays. This invention adds extra weight with the primary panel and relies on the magnets being placed throughout the primary panel surface. Since the primary surface is relied on for the secondary surfaces, this invention teaches away from using the hinge as the primary device used to secure only a primary display to a surface. U.S. Pat. No. 7,040,899 to Armstrong (2006) shows another free standing message board. This invention shows a primary surface with hinged panels for message display. Its primary use is for moving and displaying messages not in a fixed position as indicated by the carrying handle on the top of the invention. U.S. Pat. No. 5.948,498 to Bianco (1999) shows a magnetic wall mount message board that features multiple sections for various message types. Though this invention combines many previous designs into one, it is still only a message board. This invention does not incorporate a hinge. U.S. Pat. No. 5,947,825 to Rosen (1998) shows a refrigerator mount message center with one or more hinged panels.

The invention allows the expansion of the message center using the hinged panels. The messages displayed are only shown on the front surfaces of the base panel as well as the front surface of the hinged modules in the open position

The invention is used to hide the messages when all the panels are closed. U.S. Pat. No. 5,528,796 to Perry (1996) shows a hinged display that allows the message to be placed flat on a desktop. This patent teaches away from any wall mountings and is intended for desktop computing/data entry aid. U.S. Pat. No. 5,430,965 to Lai (1995) shows a message board apparatus for stabilizing a message in a automobiles using suction cups. The device is also shown on a refrigerator but the message is always parallel with the surface it is mounted to. The invention also includes lighting presumably to see the message in low lighting. There is no hinge to the design. U.S. Pat. No. 5,161,321 to Kuhnke (1992) uses a primary base for the display for storage and the display as a cover to the storage. The hinge is integral to the base and display with the base used to support the display. This invention relies on the base panel to support the main display and not the hinge itself. U.S. Pat. No. 5,131,849 to Perrero (1991) uses a primary base for a display and secondary displays as a cover to the base display. The hinge is integral to the base and display with the base used to support the display. This invention relies on the base display to support the main display and not the hinge itself. U.S. Pat. No. 4,828,502 to Leahy (1989) has a primary base display with a hinged cover panel to cover the message when not in use. The panel can serve as a picture of dry erase display but relies on the base panel wall mounts for support. The base wall mount is required. The current invention replaces this base panel with only the hinge to mount the display. U.S. Pat. No. 7,347,020 to Ray (2008) shows a message board with a hinge that is nothing more than a box mounted on the wall. The utility of this design is to allow the message board to also hold messaging supplies or other items. The message board doubles as a frame for art work when the compartments are closed. U.S. Pat. No. 4,738,043 to Ernst (1988) is another frame type display using a hinge to swing the cover away in order to change the message behind the frame. The door that swings is see through and is nothing more than a frame for the underlying message. U.S. Pat. No. 4,869,452 to Bennett (1989) has a unique hinge mechanism primarily used to flip paper and provide a dual surface for ordinary pads. The device is intended to be placed on a table top. Patent 4,545,768 to Hinnen (1985) a base with multiple compartments as well a secondary hinged panels that also have compartments. These panels rely on the base panel for the wall mount support. Since the base and panels contain compartments, this presumes more mass and a greater mounting force to support the entire invention. The panels rely on the base compartment for support and not just a hinge directly mounted to the wall. U.S. Pat. No. 4,466,639 to Fennegan (1984) shows a hinged clip board with a magnetic insert for easy removal of a note pad. The invention teaches away from any wall mounting for use. U.S. Pat. No. 7,469,869 to Killion (2008) is a device interface to allow a magnetic connection to a non magnetic surface. This device could be used on refrigerators but is only part of a message display system. It does not contain a hinge mechanism which would defeat the purpose of the magnets. U.S. Pat. No. 2,655,740 to B. F. Goodrich shows a large scale display system. This system has a substantial bas panel that support hinged display with opposing surfaces to display messages. This invention is designed as an alternative to standard chalk black boards and would not be appropriate in a home environment. U.S. Pat. No. 98,458 to Bowman, George F. (1869) is a display device with a main hinge that interconnects the display with two covers. The device purpose is to provide a convenient, cheap frame for slat displays and a convenient mechanism for replacing said slate if the slat breaks. The invention steers away from the current invention presented in that its intended use is not for stationary applications.

All of the message board designs are fixed in position once mounted. Some have a replaceable or compartment in addition to the message board but the emphasis on these additional features are additional compartment(s) for containing items or a surface that can be replaced for design reasons. All use a fixed position mounting to the surface that also restricts the message feature of the board. Since the message part is presented in parallel with the surface that the message board is mounted to, there is only one primary viewing angle to the message board. Also, The mounting of the prior art relies on multiple contact point covering the horizontal and vertical contact positions.

The following is a tabulation of some prior art that presently appears relevant:

U.S. Patents

| Patent Number | Kind Code | Issue Date | Patentee |
|---|---|---|---|
| 8,047,851 | 434/408 | Nov. 1, 2012 | Baxter; Tracy |
| 7,040,899 | **434/430 | May 9, 2006 | Armstrong, Ronald G. |
| 5,948,498 | 428/81 | Sep. 7, 1999 | Bianco; Ronald M. |
| 5,987,825 | 52/36.1 | Nov. 23, 1999 | Rosen; Lawrence I. |
| 5,528,796 | 16/355 | Jun. 25, 1996 | Perry; John M. |
| 5,430,965 | 40/597 | Jul. 11, 1995 | Lai; Shih-Wang |
| 5,161,321 | 40/493 | Nov. 10, 1992 | Kuhnke, Horst F. |
| 5,131,849 | 434/281 | Oct. 4, 1991 | Perrero, John J. |
| 4,828,502 | 434/416 | May 9, 1998 | Leahy, David J. |
| 7,347,020 | 40/781 | Mar. 25, 2008 | Ray, et al. |
| 4,738,043 | 40/618 | Apr. 19, 1988 | Ernst, Paul F. |
| 4,869,452 | 248/441.1 | Sep. 26, 1989 | Bennett; Paul L. |
| 4,545,768 | 434/304 | Oct. 8, 1985 | Hinnen, John |
| 4,466,639 | 281/45 | Aug. 21, 1984 | Finnegan; Charles L. |
| 7,469,869 | 248/309.4 | Dec. 30, 2008 | Killion; Thomas |
| 2,655,740 | 434/414 | Oct. 20, 1953 | Goodrich, S. F. |
| 98,458 | 434/422 | Dec. 28, 1869 | Bowman, George F. |

U.S. Patents Application Publications

| Patent Number | Kind Code | Issue Date | Patentee |
|---|---|---|---|
| 2007/0290588 | 312/401 | Dec. 20, 2007 | Oh; Seung-jin |
| 2006/0225331 | 40/600 | Oct. 12, 2006 | Evans, Rodney E. |

Foreign Patents Documents

| | | | | |
|---|---|---|---|---|
| Foreign Doc. | | | | |
| No | Cntry Code | Kind Code | Publ. Date | App or Patentee |

### Advantages

The mounting of the prior art relies on multiple contact point covering the horizontal and vertical contact positions. These designs needlessly require a baseboard in the event that a feature, such as a hinged message board is added. The advantage of the current invention leaves clear the underlying surface by locating the mounting along only one edge of the message board. The depth of this hinge could be varied to easily close over existing items such as mantic paper holders, pictures or even over other prior art flat mounted message boards. This Hinge Apparatus for Message Clip Boards adds the advantage of allowing any type of clip board to be rotated out uniquely while providing a minimal vertical mounting surface edge. The hinge in this invention has a minimal width interface for the actual portion used to attach the message board to the vertical surface. This minimal contact reduces weight or the overall system, reduces the number of contact point with the wall and, more importantly, allows the hinge to be mounted directly to the surface without using a base panel which is typical in all prior art.

A particular application would be to use this apparatus to mount a magnetic message board to the side of a refrigerator. This would allow the message board to be position forward, 90 degrees, with the surface parallel to the front of the fridge to access messages. Then when not in use, the board could be rotated back, 90 degrees to hide out of sight. The same example could also be attached to any drywall outer corners which are typically constructed with a vertical ferrous metal strip along the length of the corner. This would allow easily moving the message display to many locations in a house without damage the walls or the need for any mounting devices.

### DRAWINGS

FIG. 1 shows the invention using a one part, continuous hinge design

FIG. 1A shows the invention using a two part hinge design

FIG. 2 shows the invention using a one part, ball and socket hinge design

FIG. 3A—shows top view of invention in home position.

FIG. 3B—shows top view of invention in a perpendicular position.

FIG. 3C—shows top view of invention in an extended angle position

### DRAWINGS—LIST OF REFERENCE NUMERALS

10 Message Board
20 Hinge to Board Interface
30 Hinge—Board Side
40 Hinge—Mounting Surface Side
50 Hinge to Wall Interface
60 Hinge Pivot
70 Target Surface

### DETAILED DESCRIPTION

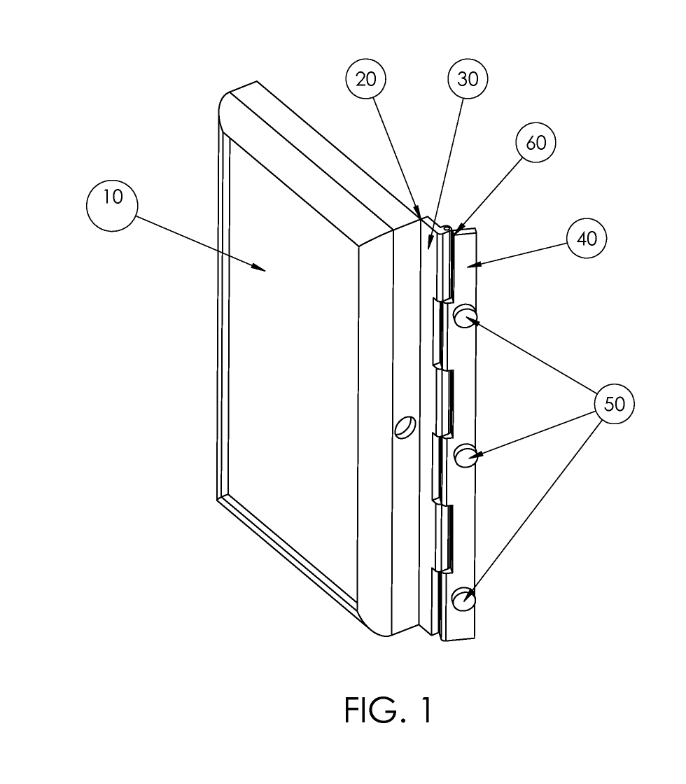

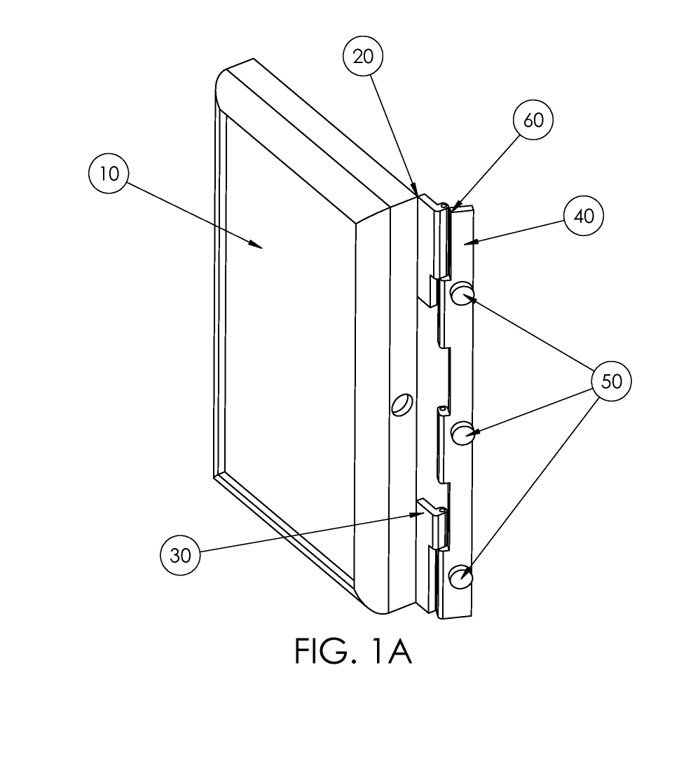

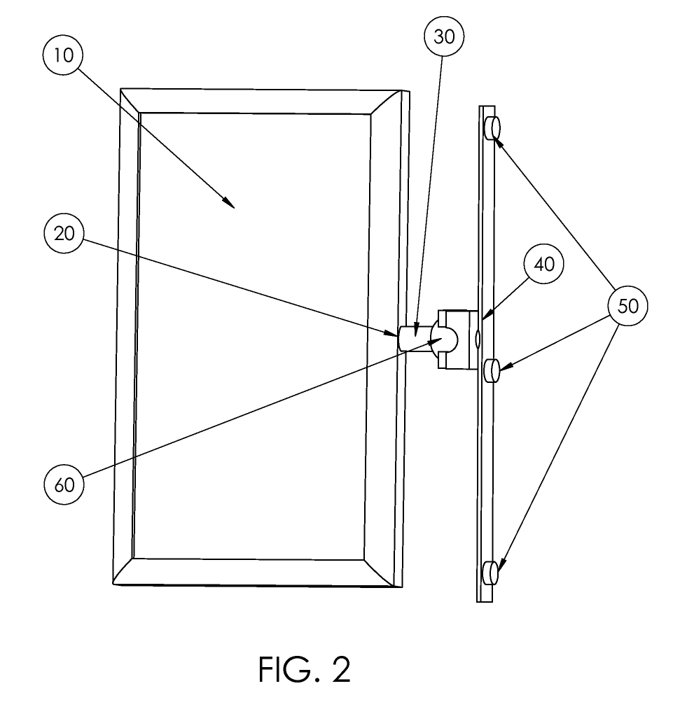

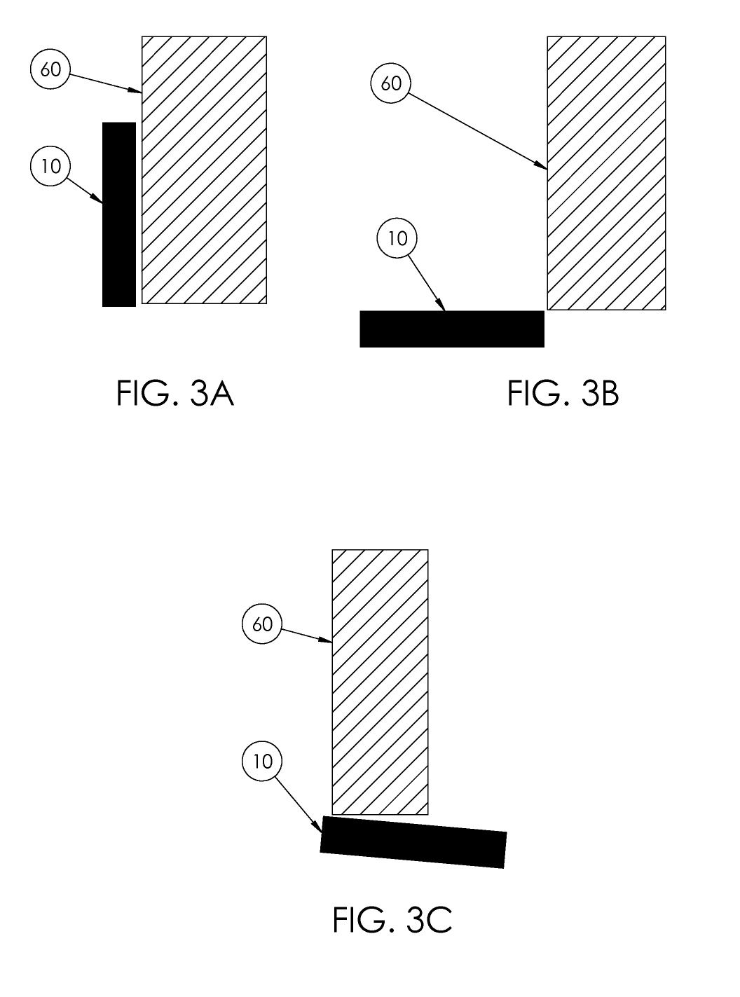

FIG. 1 shows the entire invention describe herein showing the major components of the invention. A message board 10 is represented and can be any variety of boards currently on the market. Variation would include marker eraser board, magnetic boards, quark and material boards or any combination thereof. The hinge to board interface 20 represents the contact of said board side hinge 30 with said message board 10. Said interface 20 can be built into said message board 10 and/or be an integral part of the board frame or board itself. This may take the form of pegs or holes that would completely eliminate said board side hinge 30. Hinge Pivot 60 represents the pivotal mechanism that allow said hinge 20 to pivot with the wall side hinge 40. Said hinge 60 shown uses a multi-cylindrical interlocking configuration that may have a solid shaft running through each interlocking piece. FIG. 1A shows a two part hinge design instead of a continuous hinge design where said hinge 60 may also consist simply as a vertical hole for said hinge 30 that receive a vertical peg from said hinge 40. Hinge to wall interface 50 represents the means to connect the said hinge 40 to the target surface 70. As shown, said hinge to wall interface 50 shows a plurality of devices that would cause said hinge 40 to be secured with the proper shear and tear strength to the target surface to hold said message board 10 along all pivotal positions desired along hinge pivot 60. Hinge to wall interface 50 could also be a single continuous contact. The material for said hinge to wall interface 50 could include a magnetic material for a target surface 70 that is Ferris, double sticky tape or glue for other target surfaces. FIG. 2 shows a variation of the hinge mechanism 60 using a single ball and socket type hinge. Hinge to board interface 20 is a single contact that may also allow the message board 10 to be rotated perpendicular to the message board side hinge 30. FIG. 3 shows the possible motion range for the hinge 60.

### Operation

Hinge to wall interface 50 would be used to attach said message board 10 so that the vertical edges of said message board 10 are perpendicular with the floor or ceiling. This would assure that the position of said message board surface 10 with reference to said target surface 70 to move from parallel to at least 90 degrees from the target surface 70 (FIG. 3). The position of the board would remain stationary at any position (i.e. 10°, 45°, 90°, 180°). In the case of a ball and socket hinge design, the message board would also be allowed to tilt along the ball and socket joint for a single ball-joint hinge configuration.

### Conclusion, Ramifications, and Scope

The hinged apparatus for message clip boards invention described has the major advantage of allowing any style message board to be mounted to the side of an object, like a refrigerator, and allow the message board to swing up to 270 degrees from the mounting surface to allow the message board various visibility options. Since the mounting to the desired surface is a vertical bar, a minimum metal corner is all that is needed to mount the message board. A primary application would involve the outside wall of common household refrigerators. A message board mounted on the side with the ability to swing back would eliminate unsightly notes typically stuck to the front surface of the refrigerator door. Also, since a predominant fridge door material is currently stainless steel, which is nonmagnetic, current, magnets and magnetic clip boards do not have sufficient ferrous material to create a good magnetic bond to (if any at all). The sides of the current style refrigerators, however, are mostly painted steel which would make a magnetic hinge to target wall ideal for the invention. A secondary application would involve any wall or fixture with a vertical metal edge or corner. This can involve any drywall corner in a house that has the metal reinforced strip used under the drywall mud. Any strip would allow the board to be mounted to without the need for any special mounting hardware.

1-20. (canceled)

21. A message board comprising:
a. a hinge positioned in parallel with one outer vertical edge of said message board with a message board side and a mounting surface side attached together by a pivot means. Said mounting surface side having a minimal vertical width in contact with a mounting surface and a maximum height in contact with said mounting surface less than 150% of the height of said message board vertical height.
b. means for attaching said mounting surface side to a target surface;

22. The message board with pivot means of claim 1 wherein said means for attaching said mounting surface side is a continuous magnet strip between the said mounting surface side and said target mounting surface to mount to.

23. The message board with pivot means of claim 1 wherein said means for attaching said mounting surface side is a plurality of individual magnets between the said mounting surface side and said target mounting surface to mount to.

24. The message board with pivot means of claim 1 wherein said means for attaching said mounting surface side is plurality of suction cups between the said mounting surface side and said target mounting surface to mount to.

25. The message board with pivot means of claim 1 wherein said means for attaching said mounting surface side is adhesive tape between the said mounting surface side and the target mounting surface to mount to.

26. The message board with pivot means of claim 1 wherein said message board side pivot means is integral to the message board vertical edge in the form of a hole to peg combination that forms said pivot means.

27. The message board with pivot means of claim 1 wherein said message board side is attached using a means for securing said message board side to said message board.

28. The message board with pivot means in claim 7 where said means for securing said message board side to said message board is two way tape.

29. The message board with pivot means in claim 7 where said means for securing said hinge message board side to said message board is glue.

30. The message board with pivot means in claim 7 where said means for securing said hinge message board side to said message board is a single point near the center of said message board.

31. The message board with pivot means in claim 7 where said means for securing said message board side to said message board is integral to one of the vertical frame edges of said message board.

32. The message board with pivot means in claim 1 wherein said pivot means is a single ball and socket.

33. The message board with pivot means of claim 12 wherein said single ball and socket pivot means is attached along one vertical edge of said message board.

34. The message board with pivot means of claim 12 wherein said single ball and socket pivot means is attached along any edge or back side of said message board.

35. The message board with pivot means of claim 1 wherein said pivot means is plurality of ball and socket joints in series.

36. The message board with pivot means of claim 15 wherein said single ball and socket pivot means is attached along one vertical edge of said message board.

37. The message board with pivot means of claim 15 wherein said single ball and socket pivot means is attached along any edge or back side of said message board.

38. The message board with pivot means of claim 1 wherein said pivot means is a single hinge along one vertical edge of said message board.

39. The message board with pivot means of claim 1 wherein said pivot means is a single hinge along a portion of one vertical edge of said message board.

40. The message board with hinge of claim 1 wherein said pivot means is a plurality of hinges along at least 2 sections of one vertical edge of said message board.
